(19) United States
(12) Patent Application Publication
(10) Pub. No.: US 2008/0195962 A1
(43) Pub. Date: Aug. 14, 2008

(54) Method and System for Remotely Controlling The Display of Photos in a Digital Picture Frame

(76) Inventors: Daniel J. LIN, San Francisco, CA (US); Christopher K. Hess, San Francisco, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/743,129

(22) Filed: May 1, 2007

Related U.S. Application Data
(63) Continuation-in-part of application No. 11/674,081, filed on Feb. 12, 2007.

(51) Int. Cl. G06F 3/048

(52) U.S. Cl. 715/771

(57) ABSTRACT

A system is provided for enabling a user to access a centralized account through a web browser on a terminal in order to remotely manage the display of digital photos on a digital picture frame. Any modifications made by user through the web browser are transparently sent to the digital picture frame where a client application receives such modification information and interacts with the frame's file system to reconcile such modifications.

### CROSS REFERENCE TO RELATED APPLICATIONS

This application is a continuation-in-part of U.S. patent application Ser. No. 11/674,081, filed Feb. 12, 2007, entitled “Method and System for a Hosted Mobile Management Service Architecture,” which is hereby incorporated by reference.

### FIELD OF THE INVENTION

The present invention relates generally to an architecture for a hosted management service for wirelessly networked devices and, more specifically, techniques for remotely managing digital photos to be displayed on a digital picture frame with wireless network capabilities.

### BACKGROUND OF THE INVENTION

With the rise of popularity of digital photography, digital picture or photo frames have arisen to provide consumers a traditional way of viewing digital photography in a frame capable of displaying digital formats. The first generation of such digital picture frames contained built-in memory-card slots and USB ports, allowing the user to display or transfer photos to the frame directly from his camera or computer. For example, the back of the Philips 9FF2M4 digital photo frame contains slots for Compact Flash, SD, MMC xD and Memory Stick memory cards and also contains a USB port to upload photos from the user's digital camera or computer. Photos can be transferred into the built-in memory of the frame or displayed directly through the memory cards or USB port. Such digital picture frames distinguish themselves through the design of the frame; quality and size of the display panel; size of the built-in memory; processing power to crop, rotate, and resize digital photos for display; GUI and buttons for photo and menu setup and navigation; additional features such as slide shows, replaceable faceplates, transition and collage effects; rechargeable batteries; remote controls; and video and audio display and play capabilities.

The most recent generation of digital picture frames is represented by Ceiva's digital photo frames and subscription service. In addition to the first generation capabilities of memory cards and USB connections, Ceiva's digital photo frames provide the capability to upload digital photos stored by the user to an online user account accessible at Ceiva's web site. Users upload photos from their computer or mobile phone into online-based photo albums and then choose which photos to send to (or remove from) the frame and have new updates delivered daily or hourly. For example, users can connect the Ceiva digital picture frame to an analog dial-up phone line which connects to the user's online Ceiva account at the end of each day. Alternatively, a corded Ethernet connection adapter or wireless network adapter can be used to connect the frame to a user's home network for broadband access to Ceiva's web site in a similar fashion.

Similar to the Ceiva digital picture frames, Kodak's EasyShare EX-811 Digital Frame also provides Wi-Fi capabilities that enable the frame to communicate via the user's home network with Kodak's EasyShare Gallery web site. Unlike Ceiva's digital picture frames which download new photos from the Ceiva web site on a nightly basis, Kodak's frame displays a user's Kodak EasyShare Gallery photos on an on-demand basis rather than storing them locally in the built-in memory of the frame. A user enters his EasyShare Gallery username and password via the menus and a virtual keyboard (displayed on the frame's screen) into the Kodak frame which is then able to access the user's account in Kodak's EasyShare Gallery web site. Other Wi-Fi enabled digital picture frames may also included similarly embedded web servers or RSS readers that enable the frames to initiate communication with other third party online photo sites.

Current digital picture frames, as described in the foregoing, do not provide an easy solution to initiate the changing of photos on a digital picture frame from a remote location. While the Ceiva and Kodak digital frames do provide Wi-Fi access to photos stored on web sites, the digital frames themselves initiate contact with the web site rather than the reverse. One reason that the web site cannot initiate contact with the frame is that the web site cannot ascertain the IP address of the digital frame in the home network due to dynamic IP addressing issues and firewall issues. For example, Ceiva frames initiate contact with the Ceiva site on a nightly basis and users utilize the menus on the Kodak frames to initiate a connection to Kodak's EasyShare Gallery. Furthermore, such current digital picture frames do not provide the ability to access photos stored on web sites or other remote servers if there is no Wi-Fi access. Additionally, setup procedures to connect the frames to a Wi-Fi home network (e.g., entering security passcodes into the frame, etc.) can be difficult and cumbersome. The inability to remotely initiate the changing of photos displayed on the frame compounded by the requirement for Wi-Fi connections and the difficulties in setting up such Wi-Fi connections restricts widespread adoption of currently existing digital picture frame solutions. For example, the foregoing limitations make it less desirable to send a digital picture frame as a gift to a relative (e.g., grandmother) who does not have a home network. What is needed is a digital picture frame that supports the capability of receiving photos remotely without the use of a home network.

### SUMMARY OF THE INVENTION

The present invention provides a wireless synchronization architecture wherein the addition or deletion of digital photos and albums are managed and initiated through actions made by a user through a web site rather than through the digital picture frame. With such an invention, a person can send as a gift a digital picture frame to a relative who does not have a broadband network connection in the home and that person can remotely change the pictures displayed on the frame at will. In particular, a digital picture frame as further detailed herein comprises in part a network communication component for communicating with a remote server over a cellular wireless network system (i.e., a Wi-Fi connection is not required to communicate with the remote server). A client application is installed or embedded in the digital picture frame and runs in the background to process synchronization requests received from a server wherein such server manages activities made by a user on a web site (such a server, hereinafter, may be generally referred to as the “web site”). As further described in the Detailed Description, the client application may interact with the digital picture frame's file system to add and remove photos on the digital picture frame. When the client application receives a synchronization initiation message from the web site through an “out of band” channel such as the Short Message Service (“SMS”), the client application then establishes a reliable network connection such as TCP or HTTP through the cellular network with the web site and receives data and synchronization instructions from the web site until the synchronization process is completed. Once the synchronization process is completed, the digital picture frame can thereafter display updated digital photos and albums as transferred from the web site.

In addition to the digital picture frame itself, more generally, a system is disclosed herein for enabling a user to utilize a web site to manage digital photos for access by a digital picture frame, wherein the digital picture frame supports data packet based communications over a mobile network system. As further described in the Detailed Description, such a system comprises (a) a web server component configured to record actions taken by the user on the web site to manage the digital photos; (b) a communications engine component configured to: (i) initiate a network connection with the digital picture frame, (ii) extract, for each action, a set of file system operation instructions, and (iii) transmit each set of file system operation instructions to the digital picture frame through the network connection; and (c) a client application component resident on the digital picture frame configured to: (i) receive file system operation instructions from the communications engine component and (ii) perform file system operations corresponding to the received file system operation instructions on the file system of the digital picture frame.

Within the foregoing system, a method is also further detailed for providing a user a web site to manage digital photos for display on a digital picture frame capable of communications through a cellular wireless network, the method comprising recording actions taken by the user on the web site; extracting, for each action, a set of file system operation instructions; initiating a wireless network connection with the digital picture frame; and transmitting each set of file system operations instructions to the digital picture frame through the wireless network connection.

### BRIEF DESCRIPTION OF THE DRAWINGS

FIG. 1 depicts an embodiment of an infrastructure environment in which the present invention may be deployed.

FIG. 2 depicts an embodiment of a component architecture of the digital picture frame in accordance with the present invention.

FIG. 3 depicts an embodiment of a web page served by a server in accordance with the present invention.

FIG. 4 depicts a flow chart detailing the communication protocol among the digital picture frame, server and user's web browser in accordance with the present invention.

### DETAILED DESCRIPTION OF THE INVENTION

### A. Infrastructure Environment

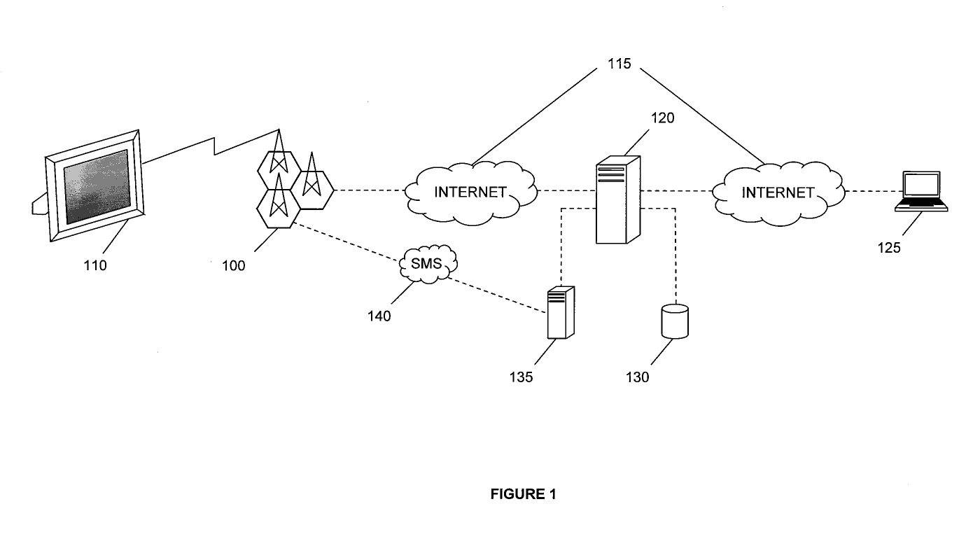

FIG. 1 depicts one embodiment of an infrastructure environment in which to deploy the present invention. An underlying digital cellular wireless network system 100 in this environment may be a 3.5G network such as HSDPA/UMTS (High Speed Downlink Packet Access/Universal Mobile Telephone System). Other possible digital cellular wireless network systems would include, without limitation, all other forms of 2.5G (e.g., GPRS, EDGE, etc.), 3G (e.g., TD-SCDMA, CDMA2000, etc.), 3.5G and future generations of packet-switched cellular wireless technologies. Because the underlying digital cellular wireless network system 100 supports packet-switching capabilities, it is able to implement an IP-based network that supports TCP/IP based communications by digital picture frame 110. Additionally, the digital cellular wireless network system 100 also supports text messaging services such as SMS (Short Message Service) 140. The digital cellular wireless network system 100 may also provide the digital picture frame 110 access to the Internet 115 through its IP-based network capabilities.

By obtaining an IP address from the underlying digital wireless network system 100, the digital picture frame 110 is able to communicate through the digital cellular wireless network system 100 through the Internet 115 and ultimately to a server 120 that hosts a digital photo management service in accordance with the present invention. In addition to communicating with the digital picture frame 110, such a server 120 may also serve web pages to an end user using an Internet connected terminal with a web browser such as 125 (e.g., laptop, personal computer, etc.) in order to provide access to the user's personal account on the server 120. The server 120 may also be coupled to a user photo database 130 in order to store users' digital photos at a centrally accessible location and an SMS gateway 135 in order to send SMS messages to the digital picture frame 110. As used hereinafter, the term and reference number “server 120” may be used generally to refer to the server side capabilities (as opposed to the client side capabilities) and therefore may include functionality resident in the database 130 and SMS gateway 135 as the context requires.

### B. Component Architecture

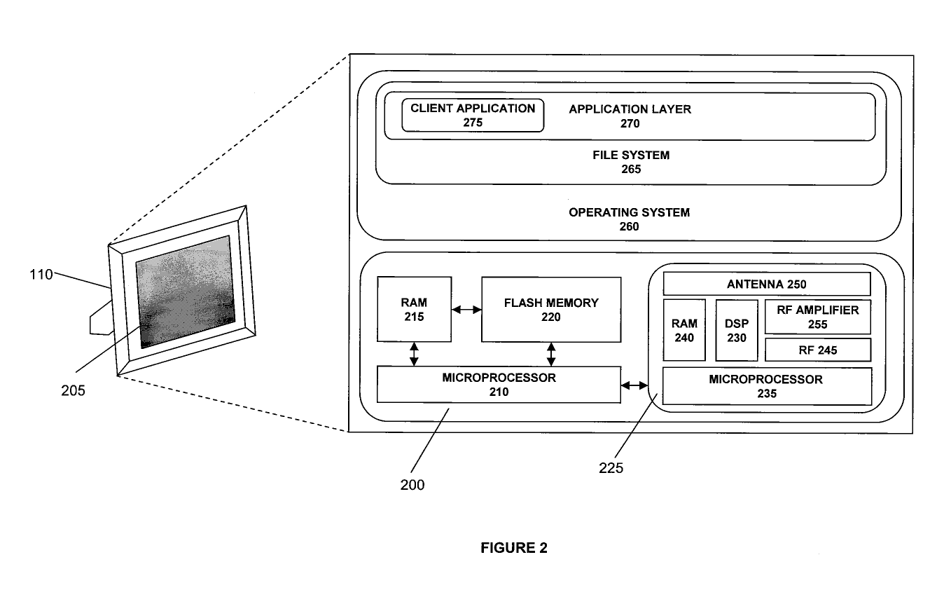

FIG. 2 depicts a component architecture of the digital picture frame 110 in accordance with the present invention. Like other typical digital picture frames, digital picture frame 110 comprises a hardware layer 200 that includes a digital display 205 such as an LCD display, a microprocessor 210 and RAM memory 215 that are used to control photo display functionality and features, and storage memory 220 such as flash memory used to store an operating system, applications as well as the user's digital photos. Unlike typical digital picture frames, the hardware layer 200 of digital picture frame 110 also contains a cellular network component that enables it to receive SMS messages from the digital cellular wireless network system 100 and utilize the data network portion (e.g., TCP/IP) of the digital cellular wireless network system 100 to communicate with the server 120. For example, digital picture frame 110 may include a cellular network communication component 225 that comprises a digital signal processor 230 to handle signal compression and decompression, microprocessor 235 and memory 240 components to deal with command and control signaling with cellular base stations in the network 100 and to generally coordinate cellular communication activities, and RF component 245 to handle the hundreds of FM channels used to communicate with the network 100, an antenna 250, and RF amplifiers 255 to handle signals in and out of the antenna. In order to receive SMS messages, the frame 110 will also be allocated a unique SMS number (e.g., assigned by a telecommunications carrier) similar to a phone number to which SMS messages can be sent by the server 120. Such an SMS number may be, for example, assigned by inserting a SIM card into the network communication component 225 of the frame 110.

The network communication component 225 may communicate with the operating system 260 which contains a file system sub-layer 265. An application layer 270 on top of the operating system 260 contains those applications needed to display the photos onto the display 205 and provide the various other features of the frame 110. For example, an application used to display photos on the digital display 205 may interact with the file system sub-layer 265 to access digital photos stored in the file system. Additionally, the present invention envisions a client application 275 that resides in the application layer 270 that receives and executes instructions received from the server 120 via the network communication component 225. This client application 275 interacts with the frame 110 at the file system layer 265 by adding or removing digital photos to or from the file system 265.

In one embodiment, the client application 275 continuously runs in the background and listens for SMS messages sent from the server 120 to the digital picture frame 110 through the SMS gateway 135. In alternative embodiments, the client application 275 may register itself to receive notification from the operating system 250 that SMS messages intended for it have arrived (e.g., similar to the “push registry” known in mobile device operating systems). When such SMS messages arrive, the operating system 260 then launches the client application 275 to consume the SMS message. As previously discussed, the client application 275 may primarily be a passive application that interacts with the file system 265 of the digital picture frame 110 only after receiving specific instructions from the server 120.

In one embodiment, the component architecture of the server 120 and user terminal 125 may be similar to those described in U.S. patent application Ser. No. 11/674,081, filed Feb. 12, 2007, entitled “Method and System for a Hosted Mobile Management Service Architecture” (hereinafter “Parent Application”), which is hereby incorporated by reference (see, e.g., FIG. 2 therein). In such an embodiment, the digital picture frame 110 is treated similarly to a mobile device in the Parent Application and the client application 275 is treated similarly as the thin client application in the Parent Application. Such an embodiment may be able to simultaneously support both mobile devices as described in the Parent Application as well as digital picture frames as described herein. However, those with ordinary skill in the art will also recognize that a “standalone” architecture of the server 120 may also be made just for the digital picture frame 110 without support for other mobile devices. Such a standalone architecture would obviate the need for an application actions database as described in the Parent Application since the only functionality/application supported by client application 275 would be the manipulation of digital photos on the frame 110 (as opposed to additional applications for music, for example, as described in the Parent Application).

Those with ordinary skill in the art will recognize that the hardware and logical components set forth in FIG. 2 are merely exemplary and that other components and configurations that provide substantially similar functionality to that of the logical components in FIG. 2 can be used consistent with the spirit and scope of the invention. For example, while portions of the network communication component 220 are set logically apart from the other parts of the digital frame 110 in FIG. 2, those with ordinary skill in the art will recognize that such separation is for logical discussion purposes only and that actual code implementations of the foregoing may not necessarily utilize such logical distinctions. For example, rather than having a microprocessor 210 and RAM memory 215 and a separate microprocessor 235 and memory 240 components in network communication component 220, a single microprocessor and RAM memory may support general digital frame photo display functionality as well as wireless network functionality. Similarly, those with ordinary in the art will recognize that various components may be implemented either in hardware or software depending upon the embodiment.

### C. User Interface

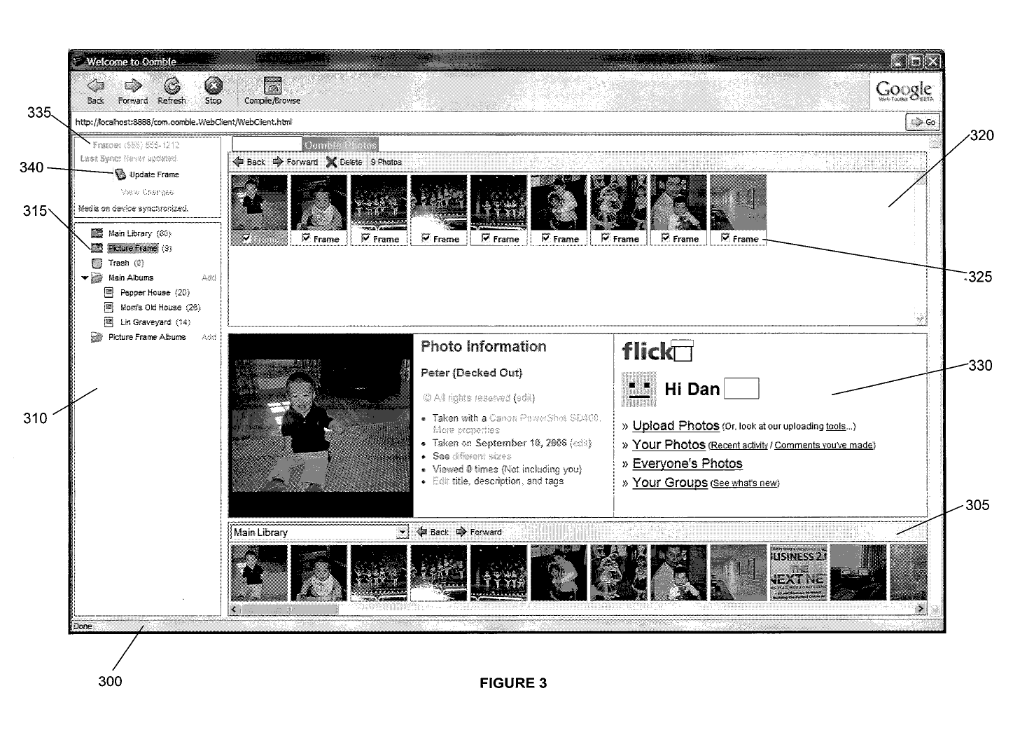

FIG. 3 depicts one embodiment of a web page that may be served by a web server of the server 120 to a web browser at the user terminal 125 to provide the user the ability to view digital photos accessible by the server 120 and on the digital picture frame 110. The selection panel 305 of web browser view 300 provides a view of all the digital photos that the user has stored in the user photo database 130 (otherwise known as “Main Library” in the navigation panel 310). The “Picture Frame” selection 315 of the navigational panel 310 has been highlighted and therefore the main panel 320 of the web browser view 300 displays all the photos that also reside on digital picture frame 110. Such photos may also be managed and indicated by the frame checkbox 325. In the embodiment of FIG. 3, a third party online photo site is also integrated into the web page at 330 such that the photos stored at the online photo provider are accessible (e.g., via a web service protocol such as REST, for example) and displayed as the Main Library. In such an embodiment, server 120 may not need a user photo database 130 to store photos (i.e., server 120 simply accesses photos stored at the user's third party online photo site). The number assigned to digital picture frame 110 for receiving SMS messages or other “out of band” messages through the cellular network 100 is displayed at 335.

To manage his digital photos, the user may easily drag and drop digital photos displayed in selection panel 305 into libraries, albums or the trash icon as set forth in navigational panel 315. Alternatively, the user may drag and drop digital photos from the main panel 320 into the icons in the selection panel 305 or may simply select the frame checkboxes such as 325 to add or remove digital photos to and from digital picture frame 110. In the embodiment of FIG. 3, changes to the digital photos made by the user on the web browser 300 are captured and tracked in the aggregate by the server 120 until the user completes his session and presses the “Update Frame” button 340, whereby the server 120 communicates with the client application 275 to propagate the additions, removals and modifications of digital photos and albums to the digital picture frame 110. In alternative embodiments, each separate change made by the user in real time may trigger a separate communication between the server 120 and the client application 275 to propagate the change to the digital picture frame 110.

Those with ordinary skill in the art will recognize that FIG. 3 is merely exemplary of numerous ways to display digital photos stored on the server 120 and digital picture frame 110 that remain consistent with the spirit and scope of the present invention. For example, while FIG. 3 only depicts a standalone user interface solely for communication with digital picture frame 110, those with ordinary skill in the art will recognize that other types of user data can be similarly stored, managed and viewed including videos, ringtones, images, games, wallpaper and PIM data. For example, an icon similar to 315 could be added to the selection panel 340 of photo user interface of FIG. 3 in the Parent Application to provide access to digital picture frame 110 through the more general mobile device hosted mobile management platform detailed in the Parent Application.

### D. Communication Protocol

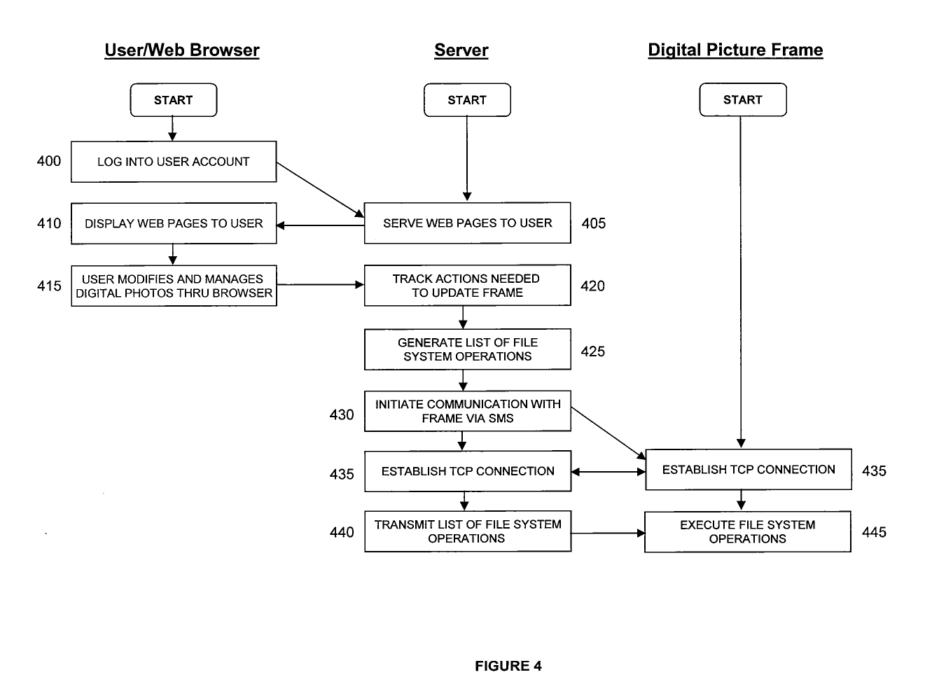

FIG. 4 depicts a communication protocol among the client application 275 in digital picture frame 110, server 120, and the user during a photo management session conducted by the user through a web browser at the user terminal 125. Initially, the user logs into his user account on the server's 120 web site though the web browser 250 (step 400). Due to the user's prior registration of the frame 110 with the server 120 (as further detailed below), server 120, by accessing the user's account data, may have knowledge of the cellular or SMS number assigned to the digital picture frame 110 (e.g., in order to receive SMS messages). Server 120 is then able to serve web pages to the user's web browser that reflect a current view of what digital photos are accessible through the server (e.g., through a third party online photo site such as 330 in FIG. 3 or as saved in user photo database 130) as well as what photos are currently residing on the digital picture frame 110 (steps 405 and 410). While the user makes various modifications to the digital photos through the web pages, for example, as previously discussed in conjunction with FIG. 3 (step 415), the server 120 records the number and type of actions (e.g., add photo, remove photo, add album, remove album, add photo to album, remove photo from album, etc.) needed to be performed on the digital picture frame 110 (step 420). Once the user has completed his session on the web page, the server 120 generates an aggregate list of file system operation instructions needed for each action made by the user during the session (step 425).

Depending upon the particular embodiment, server 120 initiates communication with the digital picture frame 110 by transmitting an SMS message via the SMS gateway 135 to the SMS number on which the client application 275 is listening (step 430). The SMS message may include the IP address of the server 120 and a session identifier (e.g., session number) used by the server 120 to keep track of the particular communication session between it and the client application 275. As previously discussed, depending upon the embodiment, for example, upon receiving the SMS message, the client application 275 may either be launched by the digital picture frame's 110 push registry or may directly receive the SMS message as a continually running background application that listens for messages on the specified SMS port. The client application 275 may then extract the IP address of the server 120 from the SMS message and establish a TCP connection with the server 120 by connecting to the IP address and identifying itself through the session identifier (step 435). Those with ordinary skill in the art will recognize that other types of network communication protocols other than TCP may be used without departing from the spirit of the invention including HTTP and other IP based network protocols. Similarly, out of band channels other than SMS may be utilized in step 430. Once the TCP connection is established, the server 120 may transmit to the client application 275 the file system operation instructions (and accompanying data for photos, etc.) to be performed by the client application 275 on the digital picture frame's file system 265 in order to reflect the changes made by the user to the web browser 250 (steps 440 to 445).

Those with ordinary skill in the art will recognize other exemplary communication protocols among the frame 110, server 120, and user that remain consistent with the spirit and scope of the present invention. For example, an initial “updating handshake” between server 120 and frame 110 similar to that detailed in FIG. 4 (steps 405 to 430) in the Parent Application can be incorporated into the communication protocol described herein in order to provide the user's web browser with an updated view of modifications to the photos made directly through the interface of the frame 110 itself. Similarly, in some embodiments, client application 275 residing on the frame 110 may be capable of communicating with the operating system 260 to dynamically control and change the current display status of the frame 110 (i.e., as the user may similar do by navigating the user interface of the frame 110 through buttons and menus). In such embodiments, server 120 may be able to transmit more complex instructions (i.e., other than just file system operations instructions) to the frame 110 in step 440 and the client application 275 may then be able to control the operation of the frame 110 in a richer fashion than adding and deleting photos and albums to the file system 265 (e.g., edit slide show characteristics, change current album display selection, etc.).

### E. Set-Up Process

Similar to FIG. 6 of the Parent Application, prior to using the services offered by server 120, a user possessing digital picture frame 110 may need to register with the server 120. In particular, the SMS number of the frame may be registered by the user such that the server 120 can send the initiating SMS message in step 430 to the frame 110. In one particular scenario, for example, a purchaser of the frame 110 may desire to send the frame to a relative as a gift but maintain the ability to remotely manipulate the photos through the purchaser's own account on server 120. The SMS number of the frame may be provided as a slip included in the packaging of the frame or as a sticker or label on the back of the frame. In other embodiments, the purchaser may be able to purchase a SIM card containing the SMS number, register the SMS number of the SIM card with server 120 prior to sending the SIM card together with the frame as the gift.

### F. Alternative Embodiments

While the present invention has been primarily described photos as the main media that are managed by the server 120 and displayed by the frame 110, those of ordinary skill in the art will recognize that alternative media and embodiments may be implemented without departing from the spirit and scope of the claimed invention. As previously discussed, other forms of media and data such as video and music may also be managed on the frame 110 through a web-enabled server in accordance with the techniques described herein. Similarly, while the present invention has been focused on digital picture frames, those with ordinary skill in the art will recognize the system and methods disclosed herein can also be applied to other network devices that have limited user interfaces, similar to digital picture frames. For example, a similar system may be implemented with respect to a car audio system in order to transfer music onto such a system. Those of ordinary skill in the art will additionally recognize that the control logic and data stored and used by the various software components as described in the foregoing specification are merely illustrative and may be redistributed various other software components and databases in alternative but functionally equivalent designs, including the removal of certain software components and/or databases, without departing from the scope or spirit of the described embodiments. For example and without limitation, the present invention has been described using TCP/IP based connections, but those of ordinary skill in the art will recognize that other packet based protocols, either on layered on top of TCP/IP, such HTTP, or as an alternative to TCP/IP may also be used to establish data transfer sessions. Terminology used in the foregoing description is for the purpose of describing the particular versions or embodiments only, and is not intended to limit the scope of the present invention which will be limited only by the appended claims. As used herein and in the appended claims, the singular forms “a,” “an,” and “the” include plural references unless the context clearly dictates otherwise. Similarly, the words “for example,” “such as,” “include,” “includes” and “including” when used herein shall be deemed in each case to be followed by the words “without limitation.” Unless defined otherwise herein, all technical and scientific terms used herein have the same meanings as commonly understood by one of ordinary skill in the art. All publications mentioned herein are incorporated by reference. Nothing herein is to be construed as an admission that the embodiments disclosed herein are not entitled to antedate such disclosure by virtue of prior invention. Thus, various modifications, additions and substitutions and the like can be made without departing from the spirit of the invention and these are therefore considered to be within the scope of the invention as defined in the following claims.

What is claimed is:

1. A system for enabling a user to utilize a web site to manage digital photos for access by a digital picture frame, wherein the digital picture frame supports data packet based communications over a mobile network system, the system comprising:
a web server component configured to record actions taken by the user on the web site to manage the digital photos;
a communications engine component configured to: (i) initiate a network connection with the digital picture frame, (ii) extract, for each action, a set of file system operation instructions, and (iii) transmit each set of file system operation instructions to the digital picture frame through the network connection; and
a client application component resident on the digital picture frame configured to (i) receive file system operation instructions from the communications engine component and (ii) perform file system operations corresponding to the received file system operation instructions on the file system of the digital picture frame.

2. The system of claim 1 wherein the web server component is further configured to access digital photos from third party online photo sites.

3. The system of claim 1 wherein the digital frame comprises a network communication component for communicating with the communications engine component over the mobile network system.

4. The system of claim 1 wherein the communications engine component initiates a network connection with the digital picture frame through an out of band connection request.

5. The system of claim 4 wherein the out of band connection request is an SMS message.

6. A digital picture frame for displaying digital photos received from a remote server, the digital picture frame comprising a network communication component for communicating with the server over a cellular wireless network system.

7. The frame of claim 6 wherein the network communication component comprises an RF component, RF amplifiers and an antenna.

8. The frame of claim 7 wherein the network communication component further comprises a digital signal processor and memory.

9. The frame of claim 6 wherein the network communication component is configured to receive SMS messages and initiate data packet based network connection with the remote server.

10. The frame of claim 6 wherein the network communication component comprises an SIM card.

11. The frame of claim 6 further comprising a client software component configured to receive instructions the remote server and execute the instructions.

12. The frame of claim 11 wherein the instructions received by the client software component relate to the addition or removal of digital photos.

13. A method for providing a user a web site to manage digital photos for display on a digital picture frame capable of communications through a cellular wireless network, the method comprising:
recording actions taken by the user on the web site;
extracting, for each action, a set of file system operation instructions;
initiating a wireless network connection with the digital picture frame; and
transmitting each set of file system operations instructions to the digital picture frame through the wireless network connection.

14. The method of claim 13 further comprising the step of extracting a digital photo file from a third party online photo provider and including the digital photo file in at least one of the file system operation instructions in at least one of the sets.

15. The method of claim 13 wherein the step of initiating a wireless network connection with the digital picture frame occurs by transmitting an SMS message to the digital picture frame, wherein the SMS message comprises an IP address.
